(19) United States
(12) Patent Application Publication
(10) Pub. No.: US 2025/0224785 A1
(43) Pub. Date: Jul. 10, 2025

(54) THERMAL CHASSIS

(71) Applicant: Google LLC, Mountain View, CA (US)

(72) Inventor: David Scott Moore, Mountain View, CA (US)

(21) Appl. No.: 18/851,979

(22) PCT Filed: Sep. 1, 2023
(86) PCT No.: PCT/US2023/031884

§ 371 Date: Sep. 27, 2024

(51) Int. Cl. G06F 1/20; G06F 1/16

(52) U.S. Cl. CPC G06F 1/203; G06F 1/1635

(57) ABSTRACT

An example mobile computing device includes a housing; a battery; one or more electronic components; and a chassis assembly removably connected to the housing, wherein the battery is connected to the chassis assembly and the chassis assembly provides a heat path from the one or more electronic components to the battery.

### BACKGROUND

Electronic devices, such as mobile computing devices, contain components that generate heat during operation. Continued operation of said components may be negatively impacted should the generated heat not be properly dissipated. For instance, operation of a processor may be adversely impacted as a temperature of the processor increases.

### SUMMARY

In general, aspects of this disclosure are directed to a mobile computing device with a chassis configured to promote heat dissipation into a battery of the mobile computing device. Components of the mobile computing device, such as a system on a chip (SoC), generate heat during operation and said heat gets dissipated via other components of the mobile computing device. In some examples, due to arrangement and connections of components in the mobile computing device, a large portion of the heat may be dissipated via a housing of the mobile computing device, particularly sides of the housing that may be held by a user of the mobile computing device. However, it may be desirable to minimize such heating of the housing.

In accordance with one or more aspects of this disclosure, a mobile computing device may include a chassis configured to promote heat dissipation from heat generating components into a battery of the mobile computing device. For instance, the chassis may carry (e.g., retain) the battery and direct heat generated by one or more components (e.g., a SoC, a radio, etc.) into the battery. While the chassis may be attached to a housing of the mobile computing device, the chassis may provide a heat flow path from the one or more components into the battery without the heat necessarily flowing through the housing. In this way, aspects of this disclosure may promote heat dissipation while minimizing heating of device housing.

In one example, a mobile computing device includes a housing; a battery; one or more electronic components; and a chassis assembly removably connected to the housing, wherein the battery is connected to the chassis assembly and the chassis assembly provides a heat path from the one or more electronic components to the battery.

The details of one or more examples are set forth in the accompanying drawings and the description below. Other features, objects, and advantages of the disclosure will be apparent from the description and drawings, and from the claims.

### BRIEF DESCRIPTION OF DRAWINGS

FIG. 1 is an exploded view of an example computing device 100 that includes a chassis configured to promote heat dissipation, in accordance with one or more aspects of the present disclosure.

FIGS. 2-5 are views of different variations of a chassis assembly, in accordance with one or more aspects of this disclosure.

FIG. 6 is a schematic diagram illustrating an example heat flow through a computing device, in accordance with one or more aspects of this disclosure.

### DETAILED DESCRIPTION

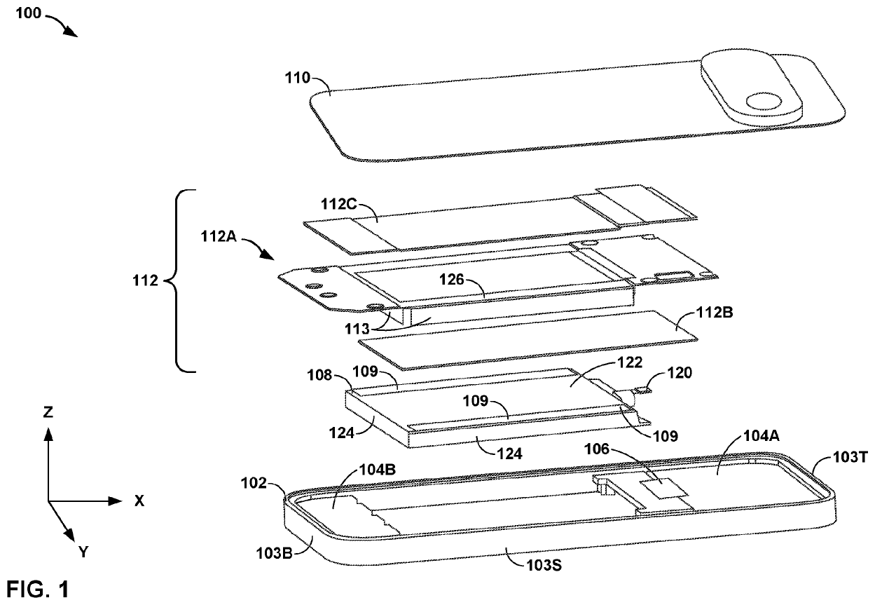

FIG. 1 is an exploded view of an example computing device 100 that includes a chassis configured to promote heat dissipation, in accordance with one or more aspects of the present disclosure. Computing device 100 may be an individual mobile computing device that includes a battery. Examples of computing device 100 include a mobile phone, a tablet computer, a laptop computer, a wearable device (e.g., a computerized watch, computerized eyewear, computerized headphones, computerized gloves, etc.), a home automation device or system (e.g., an intelligent thermostat or home assistant device), a gaming system, a media player, an e-book reader, a mobile television platform, or any other type of mobile, wearable, and non-wearable computing device.

As shown in the example of FIG. 1, computing device 100 may include housing 102, one or more circuit boards 104, one or more components 106, battery 108, cover assembly 110, and chassis assembly 112. Computing device 100 may include additional components not shown in FIG. 1, such as a display, a wireless charging coil, etc.

Housing 102 may be a component or set of components that provide external structure for computing device 100. Housing 102 may be formed from any suitable material, or materials (e.g., aluminum, steel, ceramics, etc.). Housing 102 may include sides 103S, a bottom 103B, and a top 103T. Where computing device 100 is a handheld mobile computing device, such as a smartphone, a user of computing device may be in contact with at least sides 103S.

One or more circuit boards 104A and 104B (collectively, “circuit boards 104”) may provide mechanical support and/or electrical interconnection for various electronic components of computing device 100. For instance, one or more components 106 may be attached to circuit boards 104 and circuit boards 104 may provide electrical interconnection for components 106.

One or more components 106 may be electronic components that perform various functions for computing device 100. Examples of components 106 include, but are not limited to, processors (e.g., application processors, one or more digital signal processors (DSPs), general purpose microprocessors, application specific integrated circuits (ASICs), field programmable logic arrays (FPGAs), or other equivalent integrated or discrete logic circuitry, or analog circuitry), radios (e.g., cellular radios, Wi-Fi radios, and the like), memory (e.g., RAM), etc. In some examples, components 106 may include combined components, such as a system on a chip (SoC).

Battery 108 may store electrical power and providing the stored electrical power to other components of computing device 100. Examples of battery 108 include, but are not limited to, lithium-ion, a nickel-cadmium, nickel-metal hydride, lead acid, and lithium-ion polymer batteries. In some examples, battery 108 may include a single battery. In other examples, battery 108 may include multiple batteries (e.g., to increase capacity and/or due to internal geometry). Battery 108 may, in some examples, be generally a rectangular prism having a top (e.g., primary surface 122), sides 124, and a bottom. As shown in FIG. 1, battery 108 may include connector 120, which may be connected to components on circuit boards 104 to provide power to components, such as components 106.

Cover assembly 110 may be a component or components that form an exterior surface of computing device 100. For instance, cover assembly 110 may be a rear “cover glass” that forms a rear of computing device 100. Cover assembly 110 may be attached to housing 102. While not illustrated in FIG. 1, computing device 100 may include an additional cover assembly that forms a front of computing device 100, and such additional cover assembly may include a display.

In operation, components 106 may generate heat. It may be desirable to remove such heat from components 106. For instance, operation of components 106 may be adversely impacted should components 106 get too hot. In some examples, the heat from components 106 may flow to housing 102, which may then radiate said heat into the surrounding environment. While such heat dissipation may be effective for keeping components 106 cool, it may undesirably raise a temperature portions of housing 102, such as sides 103S.

In accordance with one or more aspects of this disclosure, computing device 100 may include chassis assembly 112, which may promote heat dissipation from components 106 into battery 108. For instance, chassis assembly 112 may carry (e.g., retain) battery 108 and direct heat generated by components 106 into battery 108. As shown in FIG. 1, battery 108 may be attached to chassis assembly 112 (e.g., via adhesive 109). Similarly, chassis assembly 112 may be in contact with components 106. As such, chassis assembly 112 may provide a heat path from components 106 to battery 108. This heat path may enable heat to flow from components 106 to battery 108, while bypassing housing 102. In this way, chassis assembly may promote beat dissipation while minimizing beating of housing 102.

Chassis assembly 112 may include chassis 112A, which may be a rigid component that retains battery 108 (e.g., a metal chassis) and, in some examples, one or more other components of chassis assembly 112. As shown in FIG. 1, chassis 112A may include features configured to improve heat transfer from components 106 to battery 108. For instance, chassis 112A may include one or more flanges 113 that allow heat to flow through sides 124 of battery 108. In some examples, geometry of chassis 112, and flanges 113, may be arranged such that flanges 113 are in contact with battery 108. In addition to chassis 112A, chassis assembly 112 may include one or more of vapor chamber 112B and graphite sheet 112C. In general, vapor chamber 112B and graphite sheet 112C may aid in heat conduction from components 106 (e.g., to battery 108).

Vapor chamber 112B may operate to transport heat from components 106 to battery 108. Vapor chamber 112B may be a planar heat pipe, such as a sealed volume partially filled with a working fluid. The working fluid may evaporate within portions of vapor chamber 112B proximal to components 106, flow to other portions of vapor chamber 112B (e.g., flow both down the X axis and out along the Y axis), and subsequently condense to transfer the heat to said other portions. As shown in FIG. 1, vapor chamber 112B may extend over both components 106 and battery 108 (e.g., in the X-Y plane). Vapor chamber 112B may operate passively, without requiring battery power or generating perceptible noise.

Graphite sheet 112C may operate to transport heat away from components 106. For instance, graphite sheet 112C may act as a thermal spreader (e.g., a graphite thermal spreader) to spread the heat generated by components 106 out along the X-Y plane.

When computing device 100 is assembled, the order (moving up along the Z-axis) may be housing 102, battery 108, chassis assembly 112 (within which the order may be vapor chamber 112B, chassis 112A, graphite sheet 112C), and cover assembly 110. As discussed in more detail below, chassis 112A may have an opening such that graphite sheet 112C may be in direct contact with at least a portion of vapor chamber 112B, which in turn may be in direct contact with battery 108 and components 106 (e.g., with intervening thermal paste).

Chassis assembly 112 may be a distinct component from housing 102. For instance, chassis assembly 112 may be attached to housing 102 in a manner that facilitates removal of chassis assembly 112 from housing 102. As such, chassis assembly 112 may be considered to be removably connected to housing 102. Examples of attachment mechanisms that may be used to connect chassis assembly 112 to housing 102 include, but are not limited to, screws, snaps, magnets, clips, and the like.

With chassis assembly 112 carrying battery 108 and being removably attached to housing 102, aspects of this disclosure may improve a repairability of computing device 100. For instance, replacement of battery 108 may be accomplished via removal of cover assembly 110, removal of chassis assembly 112 from housing 102, and removal of battery 108 from chassis assembly 112. Such a procedure may provide advantages over prior devices, in particular reducing or eliminating the requirement to break adhesives such as pressure sensitive adhesive (PSA). Similarly, jumpers and other electrical connections may be routed such that removal of such connections (other than a connection from battery 108) is not required for replacement of battery 108. For instance, connections between circuit board 104A and 104B may be routed under battery 108 (e.g., lower in the Z-axis). As such, chassis assembly 112 and battery 108 may be removable from housing 102 without requiring removal of components 106.

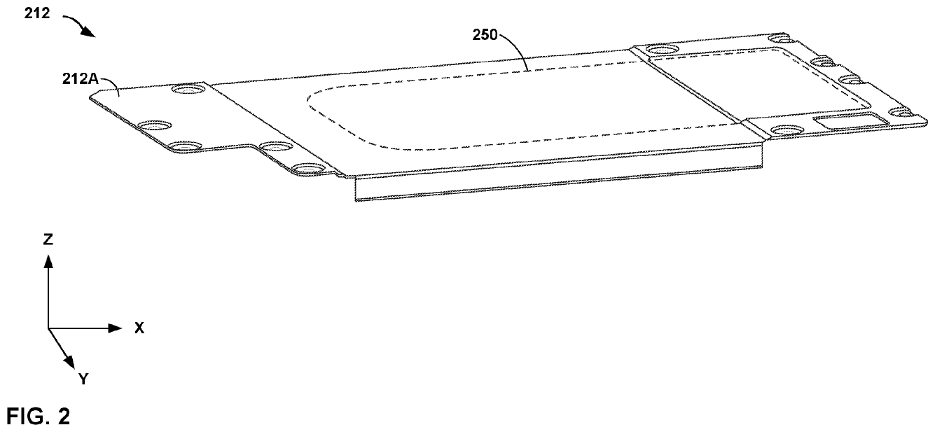

FIGS. 2-5 are views of different variations of a chassis assembly, in accordance with one or more aspects of this disclosure. The chassis assemblies illustrated in the examples of FIGS. 2-5 may all be examples of chassis assembly 112 of FIG. 1.

FIG. 2 illustrates chassis assembly 212, which may be an example of chassis assembly 112 of FIG. 1. As shown in the example of FIG. 2, chassis assembly 212 may include chassis 212A, which may be formed of a metal (e.g., aluminum, steel, titanium, etc.). Chassis 212A may be sheet metal (e.g., stamped), or diecast. In contrast to chassis 112A of FIG. 2 that includes an opening to allow graphite sheet 112C to spread heat across vapor chamber 112B, chassis 212A may be a generally solid piece of material that itself conducts heat from heat generating components to a battery (e.g., from components 106 to battery 108). In some examples, chassis 212A may include section 250 (portion of chassis 212A with the dashed outline) that conducts heat from the heat generating components to the battery.

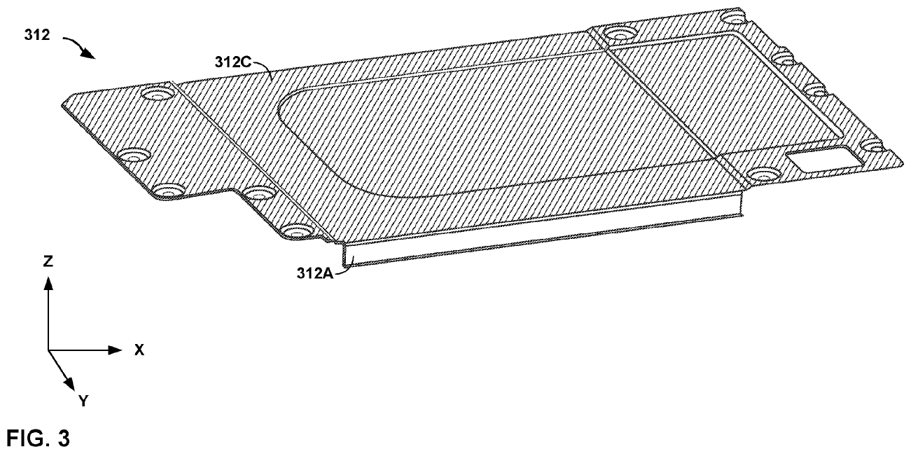

FIG. 3 illustrates chassis assembly 312, which may be an example of chassis assembly 112 of FIG. 1. As shown in the example of FIG. 3, chassis assembly 312 may include chassis 312A and graphite sheet 312C. Chassis assembly 312A may be an example of chassis assembly 212A of FIG. 2. Graphite sheet 312C may be positioned on chassis 312A and provide thermal spreading of heat. For instance, graphite sheet 312C may physically and passively assist in the transport of heat from electronic components (e.g., components 106 of FIG. 1) to a battery (e.g., battery 108 of FIG. 1).

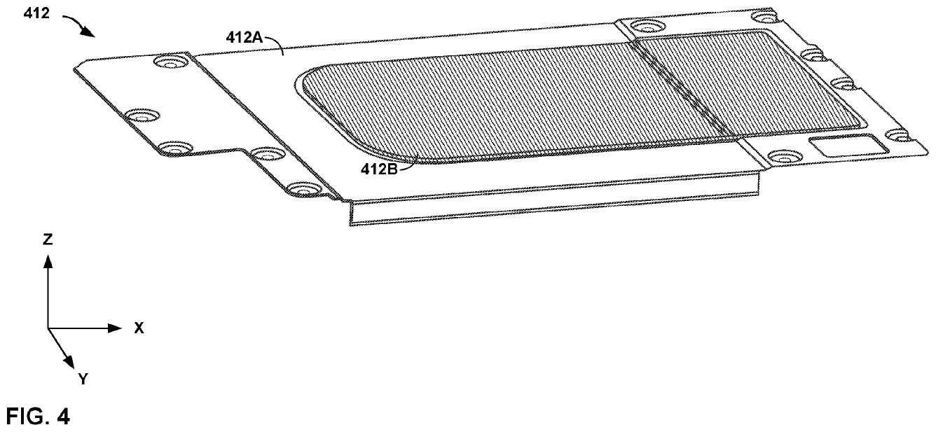

FIG. 4 illustrates chassis assembly 412, which may be an example of chassis assembly 112 of FIG. 1. As shown in the example of FIG. 4, chassis assembly 412 may include chassis 412A and vapor chamber 412B. Chassis assembly 412A may be an example of chassis assembly 212A of FIG. 2. Vapor chamber 412B may be positioned on chassis 412A and provide thermal spreading of heat. For instance, vapor chamber 412B may physically and passively assist in the transport of heat from electronic components (e.g., components 106 of FIG. 1) to a battery (e.g., battery 108 of FIG. 1). As shown in FIG. 4, vapor chamber 412B may be a discrete component that is attached to chassis 412A. For instance, vapor chamber 412B may be attached to chassis 412A via adhesive or similar means. While not shown in FIG. 4, it is understood that chassis assembly 412A may, in some examples, include a graphite sheet (e.g., similar to graphite sheet 112C of FIG. 1).

As shown in the example of FIG. 4, a section of chassis assembly 412A (e.g., corresponding to section 250 of FIG. 2) may be removed such that heat may flow into vapor chamber 412B (e.g., from the heat generating components) and out of vapor chamber 412B (e.g., into the battery) without passing through chassis 412A. For instance, the section of chassis assembly 412A may be “punched out.”

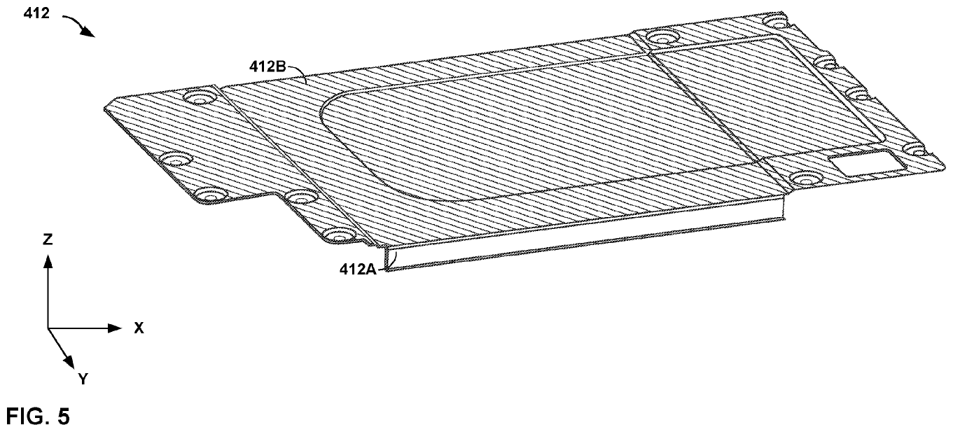

FIG. 5 illustrates chassis assembly 512, which may be an example of chassis assembly 112 of FIG. 1. As shown in the example of FIG. 5, chassis assembly 512 may include chassis 512A and vapor chamber 512B. Chassis assembly 512A may be an example of chassis assembly 212A of FIG. 2. Vapor chamber 512B may be similar to vapor chamber 412B of FIG. 4, except that vapor chamber 512B may be integrated into chassis 512A. For instance, vapor chamber 512B and chassis 512A may be formed as a single, unitary component. Having vapor chamber 512B be integrated into chassis 512A may provide some technical advantages (e.g., thinner profile, better heat spreading capacity), at the expense of higher cost. While not shown in FIG. 5, it is understood that chassis assembly 512A may, in some examples, include a graphite sheet (e.g., similar to graphite sheet 112C of FIG. 1).

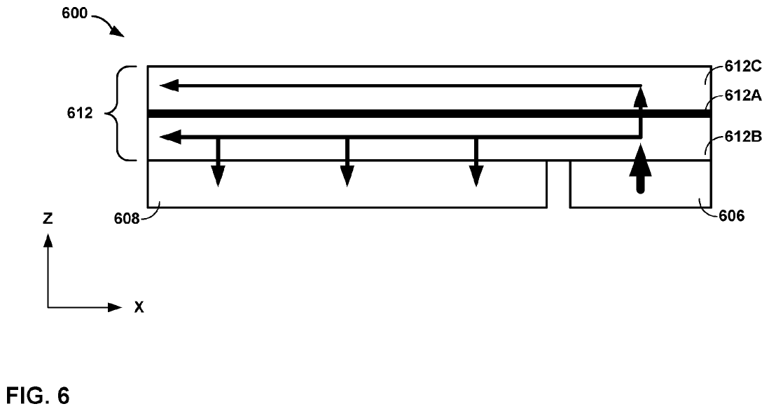

FIG. 6 is a schematic diagram illustrating an example heat flow through a computing device, in accordance with one or more aspects of this disclosure. As shown in FIG. 6, mobile computing device 600 includes components 606, battery 608, and chassis assembly 612. Mobile computing device 600 includes components 606, battery 608, and chassis assembly 612 of FIG. 6 may be examples of mobile computing device 100 includes components 106, battery 108, and chassis assembly 112 of FIG. 1. Similarly, chassis, 612A, vapor chamber 612B, and graphite sheet 612C of FIG. 6 may be examples of chassis 112A, vapor chamber 112B and graphite sheet 112C of FIG. 1. FIG. 6 may represent a cross section of computing device 600, such as on the X-Z plane of FIG. 1 (e.g., perpendicular to the Z-Y plane).

As noted above, FIG. 6 illustrates example heat flow through computing device 600. Magnitudes of heat flow through computing device 600 are approximately shown with line weights, heavier lines represent more heat. In operation, components 606 may generate heat. The heat may flow from components 606 into vapor chamber 612B. A portion of the heat may then through vapor chamber 612B into battery 608. Another portion of the heat may flow through graphite sheet 612C and chassis 612A. In this way, aspects of this disclosure may encourage a majority of heat generated by components 606 to flow through chassis assembly 612 (e.g., 80% of more of the heat).

The following numbered example may illustrate one or more aspects of this disclosure:

Example 1. A mobile computing device comprising: a housing; a battery; one or more electronic components; and a chassis assembly removably connected to the housing, wherein the battery is connected to the chassis assembly and the chassis assembly provides a heat path from the one or more electronic components to the battery.

Example 2. The mobile computing device of example 1, wherein the chassis assembly includes: a metal chassis configured to retain the battery.

Example 3. The mobile computing device of example 2, wherein the metal chassis includes material that provides at least a portion of the heat path.

Example 4. The mobile computing device of example 3, wherein the metal chassis further includes flanges in contact with sides of the battery.

Example 5. The mobile computing device of example 2, wherein the chassis assembly further includes: a vapor chamber that provides at least a portion of the heat path.

Example 6. The mobile computing device of example 5, wherein the vapor chamber extends over both the one or more electronic components and the battery.

Example 7. The mobile computing device of example 5, wherein the vapor chamber is integrated into the metal chassis.

Example 8. The mobile computing device of example 5, wherein the vapor chamber is a discrete component from the metal chassis.

Example 9. The mobile computing device of example 2, wherein the chassis assembly further includes: a graphite thermal spreader.

Example 10. The mobile computing device of example 1, wherein the battery is attached to the chassis assembly via adhesive.

Example 11. The mobile computing device of example 1, wherein the chassis assembly is attached to the housing via screws.

Example 12. The mobile computing device of example 1, wherein the one or more electronic components comprise a system on a chip (SoC).

Example 13. The mobile computing device of example 1, wherein the chassis assembly and battery are removable from the housing without requiring removal of the one or more electronic components.

Various aspects have been described in this disclosure. These and other aspects are within the scope of the following claims.

1. A mobile computing device comprising:
a housing;
a battery;
one or more electronic components; and
a chassis assembly removably connected to the housing, wherein the battery is connected to the chassis assembly and the chassis assembly provides a heat path from the one or more electronic components to the battery.

2. The mobile computing device of claim 1, wherein the chassis assembly includes:
a metal chassis configured to retain the battery.

3. The mobile computing device of claim 2, wherein the metal chassis includes material that provides at least a portion of the heat path.

4. The mobile computing device of claim 3, wherein the metal chassis further includes flanges in contact with sides of the battery.

5. The mobile computing device of claim 2, wherein the chassis assembly further includes:
a vapor chamber that provides at least a portion of the heat path.

6. The mobile computing device of claim 5, wherein the vapor chamber extends over both the one or more electronic components and the battery.

7. The mobile computing device of claim 5, wherein the vapor chamber is integrated into the metal chassis.

8. The mobile computing device of claim 5, wherein the vapor chamber is a discrete component from the metal chassis.

9. The mobile computing device of claim 2, wherein the chassis assembly further includes:
a graphite thermal spreader.

10. The mobile computing device of claim 1, wherein the battery is attached to the chassis assembly via adhesive.

11. The mobile computing device of claim 1, wherein the chassis assembly is attached to the housing via screws.

12. The mobile computing device of claim 1, wherein the one or more electronic components comprise a system on a chip (SoC).

13. The mobile computing device of claim 1, wherein the chassis assembly and battery are removable from the housing without requiring removal of the one or more electronic components.

14. A mobile computing device comprising:
a housing;
a battery;
one or more electronic components including a system on a chip (SoC); and
a chassis assembly removably connected to the housing, wherein the battery is connected to the chassis assembly and the chassis assembly provides a heat path from the one or more electronic components to the battery, wherein the chassis assembly includes:
a metal chassis configured to retain the battery, the metal chassis including flanges in contact with sides of the battery that form a first portion of the heat path; and
a vapor chamber that provides at least a second portion of the heat path.

15. The mobile computing device of claim 14, wherein the vapor chamber extends over both the one or more electronic components and the battery.

16. The mobile computing device of claim 14, wherein the vapor chamber is integrated into the metal chassis.

17. The mobile computing device of claim 14, wherein the vapor chamber is a discrete component from the metal chassis.

18. The mobile computing device of claim 14, wherein the chassis assembly further includes:
a graphite thermal spreader.

19. The mobile computing device of claim 14, wherein the battery is attached to the chassis assembly via adhesive.

20. The mobile computing device of claim 14, wherein the chassis assembly is attached to the housing via screws.
